(19) United States
(12) Patent Application Publication
(10) Pub. No.: US 2022/0192799 A1
(43) Pub. Date: Jun. 23, 2022

(54) IMPLANT SURGICAL INSTRUMENT FOR SINUS LIFT TECHNIQUE USING HYDRAULIC PRESSURE

(71) Applicant: MEDIMECCA Co., Ltd., Seoul (KR)

(72) Inventor: Jin LEE, Gwangmyeong-si (KR)

(21) Appl. No.: 17/161,760

(22) Filed: Jan. 29, 2021

(30) Foreign Application Priority Data
Dec. 18, 2020 (KR) 10-2020-0178581

(51) Int. Cl. A61C 8/00; A61C 1/00

(52) U.S. Cl. CPC A61C 8/0092; A61C 1/0061

(57) ABSTRACT

An implant surgical instrument for sinus lift technique using hydraulic pressure is provided. The implant surgical instrument for sinus lift technique using hydraulic pressure includes a body portion including a through hole inside and including an adapter outside; a fastening portion connected to one side of the body portion and having a predetermined length and screwed into an implant hole of a perforated maxilla by forming a screw thread on an outer circumferential surface; and a connecting portion connected to and formed on other side of the body portion and connected to a water supply member, wherein a diameter of the through hole disposed inside the connection portion and fastened to the water supply member in a form of a screw to prevent separation is larger than a diameter of the through hole disposed inside the fastening portion.

### CROSS-REFERENCE TO RELATED APPLICATION

This application claims priority to and the benefit of Korean Patent Application No. 10-2020-0178581, filed in the Korean Intellectual Property Office on Dec. 18, 2020, the entire contents of which are incorporated herein by reference.

### BACKGROUND OF THE INVENTION

### Field of the Disclosure

The present disclosure relates to an implant surgical instrument for sinus lift technique using hydraulic pressure. More specifically, the present disclosure relates to an implant surgical instrument for sinus lift technique using hydraulic pressure in which a water supply member and the implant surgical instrument for sinus lift technique are screwed to prevent separation from each other when the lifting is performed using hydraulic pressure, and capable of supplying water to the sinus membrane easily and conveniently without damaging the sinus membrane by preventing water leakage from occurring and maintaining the uniform water pressure and easily performing sinus lift.

### Description of the Related Art

Recently, in dentistry, an implant technique for placing artificial teeth is rapidly spreading. However, many of the patients have an oral structure that makes it difficult for implant procedure to be performed, so they suffer from difficulties in implant procedure, and some doctors avoid such patients. In particular, there is a lot of difficulty when it is difficult to place the implant due to the lack of residual bone in the posterior teeth where the maxillary sinus is located. In this case, a method of lifting a sinus membrane to form a space and then transplanting a bone in secured space and placing the implant therein is used, which is divided into two types: a vertical approach and a lateral approach. First, the vertical approach is a method when a certain amount of residual bone is secured at the implant site (the thickness of the residual bone is more than 4 mm thick), and the vertical approach is a method of tapping a maxilla several times with a tool called an osteotom (chisel and hammer) to make a hole with a diameter of 2 to 3 mm to prevent damage to the sinus membrane, and then inserting a graft bone through the hole little by little. This has the advantage of less swelling in the patient after the procedure because the treatment site is narrow, but since the maxillary sinus lining cannot be seen directly during the procedure, the procedure is checked with X-rays and the operation is carried out very carefully. For this reason, there are problems that the procedure takes a long time and a considerable discomfort to the patient occurs due to the blow in the procedure. Next, the lateral approach is a method performed when the residual bone at the implant site is very insufficient (the thickness of the residual bone is less than 4 mm thick), and is the method of forming a hole (window) on the side of the sinus to lift the sinus membrane, and then bone graft is performed. This has the advantage that the sinus membrane can be lifted while looking directly at the sinus membrane during the procedure, so that damage to the sinus membrane is less likely, and even if damage occurs, post-treatment is possible, and rapid progress is possible because a desired amount of bone graft material can be quickly inserted at a time. But since the operation itself is difficult and a large valve must be formed, there is a problem that severe edema occurs after the operation, and such a procedure is avoided.

Recently, the sinus lift was performed using an implant drill. Technique using the implant drill may have the advantage that the patient reluctance is low and maxillary perforation is possible quickly and easily, but this could not avoid the phenomenon that the sinus is torn or curled up by a tip of a drill blade because there is no means to block the tip of the drill blade from contacting the sinus membrane at the moment the maxillary perforation is completed by the rotation of the drill blade.

### PRIOR ART DOCUMENT

### Patent Document

Korean Patent No. 10-1019121

### SUMMARY

The present disclosure provides an implant surgical instrument for sinus lift technique using hydraulic pressure capable of easily and conveniently performing sinus lift without damaging the sinus membrane through a method of lifting the sinus membrane by hydraulic pressure supplied to the maxillary sinus when using an implant procedure using hydraulic pressure.

The present disclosure provides an implant surgical instrument for sinus lift technique using hydraulic pressure capable of uniformly maintaining the water pressure inside the maxillary sinus by preventing leakage of water supplied into the maxillary sinus by the implant surgical instrument for sinus lift technique using hydraulic pressure provided with a fastening part rotatably coupled with the maxillary.

The present disclosure provides an implant surgical instrument for sinus lift technique using hydraulic pressure capable of rapidly moving water to the maxillary sinu by forming a through hole located in the maxillary sinus less than the through hole where water is injected.

The present disclosure provides an implant surgical instrument for sinus lift technique using hydraulic pressure capable of compatibly using various standards of implant surgical instruments by attaching an adapter to a torque wrench that can precisely apply a prescribed amount of torque for each product.

In an aspect, there is provided an implant surgical instrument for sinus lift technique using hydraulic pressure including: a body portion including a through hole inside and including an adapter outside; a fastening portion connected to one side of the body portion and having a predetermined length and screwed into an implant hole of a perforated maxilla by forming a screw thread on an outer circumferential surface; and a connecting portion connected to and formed on other side of the body portion and connected to a water supply member.

In this case, a diameter of the through hole disposed inside the connection portion and fastened to the water supply member in a form of a screw to prevent separation may be larger than a diameter of the through hole disposed inside the fastening portion.

The adapter may include an insertion hole corresponding to shape of an outer surface of the body portion so as to be coupled to the outer surface of the body portion therein, and at least one outer circumferential groove may be formed on the outer circumferential surface of the adapter.

The outer circumferential groove may be formed in a curved shape.

The fastening portion may be formed in a shape in which the outer circumferential surface gradually decreases from top to bottom.

For example, a diameter of a top surface of the outer circumferential surface may be 4.0 mm, and a diameter of a bottom surface of the outer circumferential surface may be 3.1 mm when a fixture diameter of the implant surgical instrument for sinus lift technique using hydraulic pressure is 4.0 or 4.5.

Furthermore, the diameter of the top surface of the outer circumferential surface may be 4.9 mm, and the diameter of the bottom surface of the outer circumferential surface may be 3.9 mm when the fixture diameter is 5.0 or 5.5.

In addition, the diameter of the top surface of the outer circumferential surface may be 5.6 mm, and the diameter of the bottom surface of the outer circumferential surface may be 4.8 mm when the fixture diameter is 6.0 or 7.0.

The connecting portion may include at least one locking projection, and a diameter of the locking projection may be larger than a diameter of a coupling groove.

### BRIEF DESCRIPTION OF THE DRAWINGS

FIG. 1 is a side view for explaining an implant surgical instrument for sinus lift technique using hydraulic pressure according to an embodiment of the present disclosure.

FIG. 2 is an internal cross-sectional view of the extrusion control unit shown in FIG. 1.

FIG. 3 is a side view for explaining an implant surgical instrument for sinus lift technique using hydraulic pressure according to another embodiment of the present disclosure.

FIG. 4 is a combined view for explain an implant surgical instrument for sinus lift technique using hydraulic pressure shown in FIG. 3.

FIGS. 5A, 5B are a view for explaining a state of use of an implant surgical instrument for sinus lift technique using hydraulic pressure according to an embodiment of the present disclosure.

### DESCRIPTION OF EXEMPLARY EMBODIMENTS

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art.

The specification describes in the embodiment for the present invention the term used in which relayed a number that is even endured. In the specification, a plurality type comprises a unit in a single may be phrase will not specially mentioned. Used in specification “(comprises) comprising” and/or “including (comprising)” at least one other handle components other components does not number the presence or addition times. The same drawing code which defines the same element throughout the specification, “and/or” ensures that all components and at least one each of a combination. Although “number 1”, “number 2” is used to describe various components or the like, these components are not one number by these terms the concave disclosed. These terms have only one component used to discriminate between other components are disclosed. The, hereinafter referred to as number 1 in technical idea of the present invention components may be as well as in number 2 component are disclosed.

Unless defined otherwise, all technical and scientific terms used herein have the same meaning as commonly understood by one of ordinary skill in the art to which this invention belongs. It is noted that the use of any and all examples, or exemplary terms provided herein is intended merely to better illuminate the invention and is not a limitation on the scope of the invention unless otherwise specified. Further, unless defined otherwise, all terms defined in generally used dictionaries may not be overly interpreted.

Hereinafter, embodiments disclosed in the present disclosure will be described in detail with reference to the accompanying drawings.

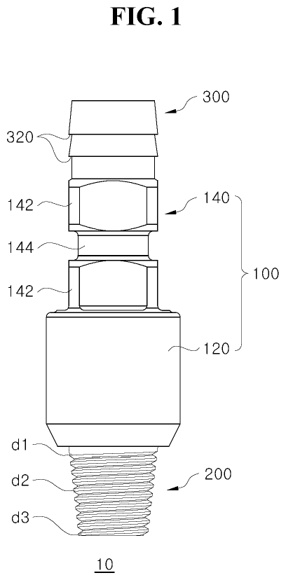

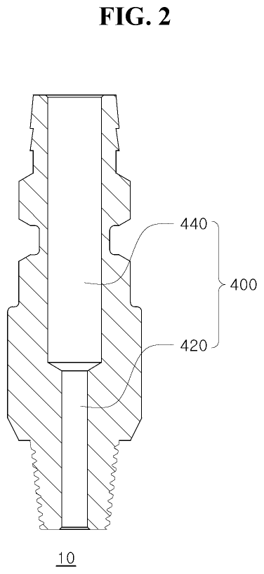

FIG. 1 is a side view for explaining an implant surgical instrument for sinus lift technique using hydraulic pressure according to an embodiment of the present disclosure, and FIG. 2 is an internal cross-sectional view of the extrusion control unit shown in FIG. 1.

As shown in FIG. 1 and FIG. 2, the implant surgical instrument for sinus lift technique using hydraulic pressure 10 according to the embodiment of the present disclosure may include a body portion 100, a fastening portion 200, and a connection portion 300. In this case, the body portion 100, the fastening portion 200, and the connection portion 300 may include a through hole 400 therein when formed integrally, but is not limited thereto.

The body portion 100 may include the through hole 400 therein, and an outer side thereof may include a flat portion 120 and a compatible component coupling portion 140.

The flat portion 120 may be formed in a cylindrical shape, and the outer surface may be formed flat.

The compatible component coupling portion 104 may be integrally connected with the flat portion 120, and an adapter 500 may be coupled to the outer surface.

In the present embodiment, the compatible component coupling portion 140 may include a coupling portion 142 formed of at least one surface and a coupling connection portion 144 connecting the coupling portion 142. In this case, although the coupling portion 142 is disclosed as two, the present disclosure is not limited thereto.

Depending on the embodiment, the coupling portion 142 may be coupled to a screw, but is not limited thereto, and may be coupled to a ratchet.

In the present embodiment, at least one surface of the compatible component coupling portion 140 is disclosed in a square shape, but is not limited thereto.

The fastening portion 200 is connected to one side of the body portion 100 and has a predetermined length, and a screw thread is formed on the outer circumferential surface thereof to be screwed into an implant hole 3 of a perforated maxilla 2. That is, the fastening portion 200 may be integrally connected with the flat portion 120 of the body portion 100.

In this case, the screw thread of the fastening portion 200 is screwed into the implant hole 3, so that it can be inserted and extracted into the implant surgical instrument for sinus lift technique using hydraulic pressure 10.

The fastening portion 200 may be formed such that the outer circumferential surface gradually decreases from a surface connected to the flat portion (120) (i.e., an upper part) to a lower part. That is, the fastening portion 200 may be formed to be inclined downward.

A diameter of a top surface of the fastening portion 200 may be larger than a diameter of a bottom surface of the fastening portion 200.

For example, the diameter d1 of a top surface of the fastening portion 200 may be 4.0 mm, the diameter d2 of a middle surface may be 3.5 mm, and the diameter d3 of a bottom surface may be 3.1 mm when a fixture diameter of the implant surgical instrument for sinus lift technique using hydraulic pressure 10 is 4.0 or 4.5.

Furthermore, the diameter d1 of the top surface may be 4.9 mm, the diameter d2 of the middle surface may be 4.4 mm, and the diameter d3 of the bottom surface may be 3.9 mm when the fixture diameter of the implant surgical instrument for sinus lift technique using hydraulic pressure 10 is 5.0 or 5.5.

In addition, the diameter d1 of the top surface may be 5.6 mm, the diameter d2 of the middle surface may be 5.3 mm, and the diameter d3 of the bottom surface may be 4.8 mm when the fixture diameter of the implant surgical instrument for sinus lift technique using hydraulic pressure 10 is 6.0 or 7.0.

The fastening portion 200 formed to be inclined downward as described above may be screwed into the implant hole 3 of the perforated maxilla 2, so that water supplied to the maxilla 2 can be prevented from leaking. In addition, by preventing the water supplied to the maxilla 2 from leaking, it is possible to keep the hydraulic pressure inside the maxillary sinus 1 uniform.

The connecting portion 300 may be connected to and formed on other side of the body portion 100 and may include at least one locking projection 320. That is, the connection portion 300 may be integrally formed with the compatible component coupling portion 140 of the body part 100.

In the present embodiment, although the locking projection 320 of the connection portion 300 is disclosed as two, the present disclosure is not limited thereto, and the connection portion 300 may include one or more locking projections 320.

The connection portion 300 having such a structure may be connected to a water supply member 4.

The water supply member 4 may include a connection member formed of a rubber material that is coupled to the locking projection 320 of the connection portion 300, a connection pipe 40 leading from the connection member, and a push rod 44 for pushing water filled in a syringe 42. By pressing the push rod 44 of the syringe 42, the water filled in the syringe 42 is supplied to the implant surgical instrument for sinus lift technique 10 through the connection pipe 40, and since the hydraulic pressure of the supplied water lift the sinus membrane, it is possible to perform the sinus lift easily and conveniently without damaging the inner membrane.

The through hole 400 may include a first through hole 420 disposed in the body portion 100 and the fastening portion 200, and a second through hole 440 disposed in the body portion 100 and the connection portion 300.

According to the embodiment, the second through hole 440 may be fastened to the water supply member 4 in the form of a screw, but is not limited thereto. Since the second through hole 440 and the connection pipe 40 of the water supply member 4 are fastened in the form of a screw, separation can be prevented and water leakage can be prevented.

The first through hole 420 and the second through hole 440 may be formed in a cylindrical shape, but are not limited thereto.

A diameter of the first through hole 420 may be smaller than a diameter of the second through hole 440, but is not limited thereto. In this case, the diameter of the first through hole 420 may be smaller than a diameter of the fastening portion 200, and the diameter of the second through hole 440 may be smaller than a diameter of the connection portion 300.

Due to the difference in diameter of the through hole 400 having a structure having a larger diameter of the second through hole 440 disposed in the connection portion 300 into which water is injected than the diameter of the first through hole 420 of the fastening portion 200 disposed in the maxillary sinus, water can quickly moves to the maxillary sinus, and only a desired part can be quickly lifted.

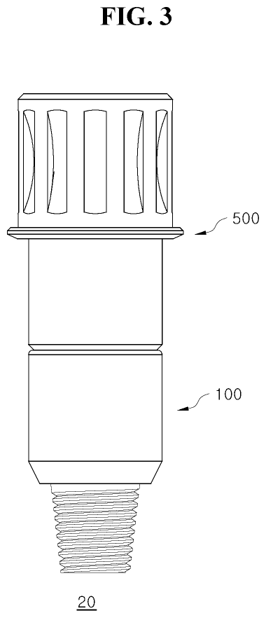

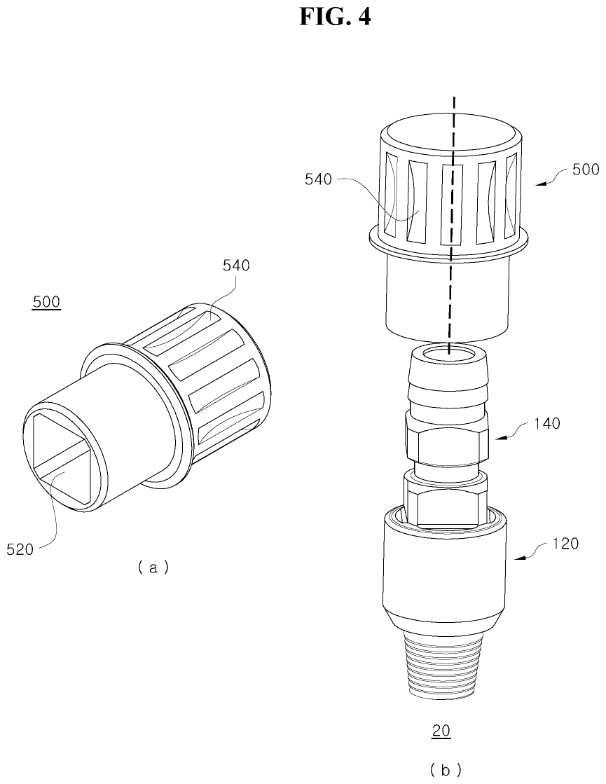

FIG. 3 is a side view for explaining an implant surgical instrument for sinus lift technique using hydraulic pressure according to another embodiment of the present disclosure, and FIG. 4 is a view for explain an implant surgical instrument for sinus lift technique using hydraulic pressure shown in FIG. 3, and FIG. 4(a) is a view for explaining the adapter, and FIG. 4(b) is a view for explaining the coupling state of the adapter and the implant surgical instrument for sinus lift technique using hydraulic pressure.

As shown in FIG. 3 and FIG. 4, the implant surgical instrument for sinus lift technique using hydraulic pressure 20 may include an adapter 500 coupled to the outside of the body portion 100.

Except for the adapter 500 shown in FIG. 3 and FIG. 4, it may have the same characteristics as the implant surgical instrument for sinus lift technique using hydraulic pressure 10 shown in FIG. 1 and FIG. 2.

In FIG. 3 and FIG. 4 below, detailed descriptions of content overlapping with those described in FIG. 1 and FIG. 2 may be omitted, and different points may be mainly described. Accordingly, components that perform the same functions as those of the implant surgical instrument for sinus lift technique using hydraulic pressure 20 shown in FIG. 3 and FIG. 4 are denoted by the same reference numerals as in FIG. 1 and FIG. 2, and detailed descriptions thereof will be omitted.

The adapter 500 may include an insertion hole 520 corresponding to the shape of the outer surface of the body portion 100 so as to be coupled to the outer surface of the body portion 100 therein, and at least one outer circumferential groove 540 formed on the outer circumferential surface.

The insertion hole 520 may be formed in a square shape corresponding to the outer shape of the coupling portion 142. That is, the insertion hole 520 may be formed in a square shape corresponding to the shape of the compatible component coupling portion 140, but is not limited thereto. In particular, it may be formed to correspond to the shape of the coupling portion 142 of the compatible component coupling portion 140.

The outer circumferential groove 540 may be formed in a curved shape, but is not limited thereto.

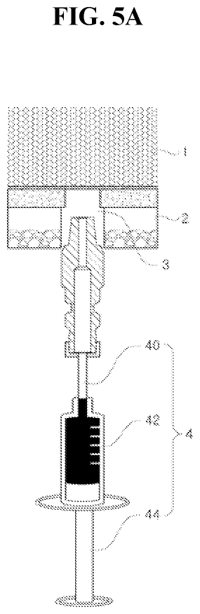

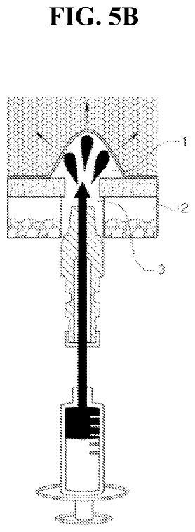

The operation of the implant surgical instrument for sinus lift technique using hydraulic pressure 10 of this structure is as follows. FIGS. 5A, 5B are a view for explaining a state of use of an implant surgical instrument for sinus lift technique using hydraulic pressure according to an embodiment of the present disclosure, and FIG. 5A is a view for explaining a state before injecting water into the sinus, and FIG. 5B is a view for explaining a state in which water is injected into the sinus.

First, as shown in FIGS. 5A, 5B, in the method of sinus lift using hydraulic pressure, the implant surgical instrument for sinus lift technique using hydraulic pressure 10 is inserted into the implant hole 3 formed to match the diameter of the implant, and inserted to the maxilla 2 under a periosteum of the maxillary sinus 1 so as not to reach the periosteum (not shown) in the maxillary sinus 1 (See FIG. 5A). Then, the water supply member 4 is connected to the implant surgical instrument for sinus lift using water pressure 10, and the periosteum of the bottom of the maxillary sinus 1 can be lifted using the hydraulic pressure generated by water (see FIG. 5B).

Moreover, due to the difference in diameter of the through hole 400 disposed in the implant surgical instrument for sinus lift technique using hydraulic pressure, water quickly move to the sinus and quickly lift only the desired part. That is, the diameter of the second through hole 440 disposed in the connection portion 300 into which water is injected is formed larger than the diameter of the first through hole 420 of the fastening portion 200 disposed in the sinus, and thus, by pressing the push rod 44 of the syringe 42, the water filled in the syringe 42 passes through the paths of the connection pipe 40, the connection portion 300, the body portion 100, and the fastening portion 200, and the periosteum of the bottom of the sinus 1 can be lifted easily and conveniently without damaging the inner membrane.

The steps of a method or algorithm described in connection with the embodiments of the present disclosure may be implemented directly in hardware, implemented as a software module executed by hardware, or a combination thereof. Software may also reside on random access memory (RAM), read only memory (ROM), erasable programmable ROM (EPROM), electrically erasable programmable ROM (EEPROM), flash memory, hard disk, removable disk, CD-ROM, or any type of computer-readable recording medium well known in the art to which the present disclosure pertains.

In the above, embodiments of the present disclosure have been described with reference to the accompanying drawings, but those of ordinary skill in the art to which the present invention pertains will be able to understand that the present invention can be implemented in other specific forms without changing the technical spirit or essential features thereof. Therefore, the embodiments described above are illustrative in all respects and should be understood as non-limiting.

What is claimed is:

1. An implant surgical instrument for sinus lift technique using hydraulic pressure comprising:
a body portion including a through hole inside and including an adapter outside;
a fastening portion connected to one side of the body portion and having a predetermined length and screwed into an implant hole of a perforated maxilla by forming a screw thread on an outer circumferential surface; and
a connecting portion connected to and formed on other side of the body portion and connected to a water supply member,
wherein a diameter of the through hole disposed inside the connection portion and fastened to the water supply member in a form of a screw to prevent separation is larger than a diameter of the through hole disposed inside the fastening portion.

2. The implant surgical instrument for sinus lift technique using hydraulic hydraulic pressure of claim 1,
wherein the adapter includes an insertion hole corresponding to shape of an outer surface of the body portion so as to be coupled to the outer surface of the body portion therein, and
wherein at least one outer circumferential groove is formed on the outer circumferential surface of the adapter.

3. The implant surgical instrument for sinus lift technique using hydraulic pressure of claim 2,
wherein the outer circumferential groove is formed in a curved shape.

4. The implant surgical instrument for sinus lift technique using hydraulic pressure of claim 1,
wherein the fastening portion is formed in a shape in which the outer circumferential surface gradually decreases from top to bottom.

5. The implant surgical instrument for sinus lift technique using hydraulic pressure of claim 4,
wherein a diameter of a top surface of the outer circumferential surface is 4.0 mm, and a diameter of a bottom surface of the outer circumferential surface is 3.1 mm when a fixture diameter of the implant surgical instrument for sinus lift technique using hydraulic pressure is 4.0 or 4.5,
wherein the diameter of the top surface of the outer circumferential surface is 4.9 mm, and the diameter of the bottom surface of the outer circumferential surface is 3.9 mm when the fixture diameter is 5.0 or 5.5, and
wherein the diameter of the top surface of the outer circumferential surface is 5.6 mm, and the diameter of the bottom surface of the outer circumferential surface is 4.8 mm when the fixture diameter is 6.0 or 7.0.

6. The implant surgical instrument for sinus lift technique using hydraulic pressure of claim 1,
wherein the connecting portion includes at least one locking projection, and
wherein a diameter of the locking projection is larger than a diameter of a coupling groove.
